(19) United States
(12) Patent Application Publication
(10) Pub. No.: US 2023/0169474 A1
(43) Pub. Date: Jun. 1, 2023

(54) VEHICLE PARTS INFORMATION PROCESSING DEVICE, VEHICLE PARTS INFORMATION PROCESSING METHOD, AND STORAGE MEDIUM

(71) Applicant: TOYOTA JIDOSHA KABUSHIKI KAISHA, Toyota-shi Aichi-ken (JP)

(72) Inventor: Yumi HAYASHIDA, Toyota-shi Aichi-ken (JP)

(73) Assignee: TOYOTA JIDOSHA KABUSHIKI KAISHA, Toyota-shi Aichi-ken (JP)

(21) Appl. No.: 17/977,030

(22) Filed: Oct. 31, 2022

(30) Foreign Application Priority Data
Nov. 30, 2021 (JP) 2021-194994

(51) Int. Cl. G06Q 10/00; G07C 5/08

(52) U.S. Cl. CPC G06Q 10/30; G07C 5/0808; G07C 5/006

(57) ABSTRACT

A vehicle parts information processing device includes a processor. The processor acquires parts information from a storage unit that stores the parts information related to a mounted part mounted on a vehicle, adds a diagnostic result related to a degree of deterioration to the parts information and updates the parts information stored in the storage unit, and extracts the mounted part satisfying a predetermined condition related to the degree of deterioration from the parts information stored in the storage unit.

### CROSS-REFERENCE TO RELATED APPLICATION

This application claims priority to Japanese Patent Application No. 2021-194994 filed on Nov. 30, 2021, incorporated herein by reference in its entirety.

### BACKGROUND

### 1. Technical Field

The present disclosure relates to a vehicle parts information processing device, a vehicle parts information processing method, and a storage medium.

### 2. Description of Related Art

Japanese Unexamined Patent Application Publication No. 7-303873 (JP 7-303873 A) discloses a recycling system in which a product is provided with information at the time of manufacture, information at the time of use, maintenance information such as maintenance and repair, etc., a product specification database, a recycling processing method database, etc. are separately provided from the product, and the product is recycled based on the information above.

### SUMMARY

However, in the recycling system described in JP 7-303873 A, a specific method for appropriately reusing mounted parts of the vehicle has not been studied.

An object of the present disclosure is to obtain a vehicle parts information processing device, a vehicle parts information processing method, and a storage medium capable of appropriately reusing the mounted parts of a vehicle.

A vehicle parts information processing device in a first aspect includes a processor. The processor acquires parts information from a storage unit that stores the parts information related to a mounted part mounted on a vehicle, adding a diagnostic result related to a degree of deterioration to the parts information and updating the parts information stored in the storage unit, and extracting the mounted part satisfying a predetermined condition related to the degree of deterioration from the parts information stored in the storage unit.

In the vehicle parts information processing device according to the first aspect, the part information related to the mounted parts mounted on the vehicle is stored in the storage unit. The processor acquires the parts information from the storage unit, and adds the diagnostic result related to the degree of deterioration to the parts information and updates the parts information. With the above, the parts information stored in the storage unit includes information related to the degree of deterioration of the mounted parts. Further, the processor extracts the mounted part satisfying a predetermined condition related to the degree of deterioration from the parts information stored in the storage unit. With the above, for example, only the mounted parts having the same degree of deterioration can be extracted, and only the mounted parts having the same degree of deterioration can be reused to remake the vehicle. Note that, the term “diagnostic result related to the degree of deterioration” as used herein is not limited to information that directly indicates the degree of deterioration, but is a concept that broadly includes information indicating the degree of deterioration indirectly, The information indicating the degree of deterioration indirectly is, for example, information including the traveling area and the mileage of the vehicle.

In the vehicle parts information processing device in a second aspect according to the first aspect, the processor extracts the mounted part of which the degree of deterioration is within a predetermined range from the diagnostic result for each of the mounted parts constituting the vehicle.

In the vehicle parts information processing device according to the second aspect, the vehicle is remade using only the mounted parts of which degree of deterioration of the mounted parts is within a predetermined range. With the above, for example, each of a plurality of necessary parts such as an engine mount member can be made to have the same degree of deterioration, and the replacement time can be made to be the same.

In the vehicle parts information processing device in a third aspect according to the second aspect, the processor calculates a sales price of the vehicle when the vehicle is remade using the extracted mounted part, and stores the parts information of the extracted part and information related to the sales price in the storage unit.

In the vehicle parts information processing device according to the third aspect, the sales price of the vehicle can be calculated on the system before the vehicle is actually remade. Further, the mounted parts can be efficiently collected and the sales preparation can be performed when the remake of the vehicle is determined, by storing the parts information and the information related to the sales price in the storage unit.

In the vehicle parts information processing device in a fourth aspect according to the third aspect, the processor calculates the sales price in consideration of vehicle information of the vehicle on which each of the extracted mounted parts is mounted.

In the vehicle parts information processing device according to the fourth aspect, the sales price can be calculated in consideration of the location of the vehicle on which the mounted parts are mounted and the man-hours required for disassembling the vehicle and taking out the mounted parts.

In the vehicle parts information processing device in a fifth aspect according to any one of the first aspect to the fourth aspect, the processor deletes the parts information of the mounted part of which the degree of deterioration is large from the storage unit.

In the vehicle parts information processing device according to the fifth aspect, only the information of the parts that can be used for the remake of the vehicle can be stored by deleting the parts information of the mounted part of which degree of deterioration is large from the storage unit.

A vehicle parts information processing method according to a sixth aspect includes: acquiring parts information from a storage unit that stores the parts information related to a mounted part mounted on a vehicle; adding a diagnostic result related to a degree of deterioration to the parts information and updating the parts information stored in the storage unit; and extracting the mounted part satisfying a predetermined condition related to the degree of deterioration from the parts information stored in the storage unit.

A storage medium according to a seventh aspect stores a program that causes a computer to execute processes including: acquiring parts information from a storage unit that stores the parts information related to a mounted part mounted on a vehicle; adding a diagnostic result related to a degree of deterioration to the parts information and updating the parts information stored in the storage unit; and extracting the mounted part satisfying a predetermined condition related to the degree of deterioration from the parts information stored in the storage unit.

As described above, according to the vehicle parts information processing device, the vehicle parts information processing method, and the storage medium according to the present disclosure, the mounted parts of the vehicle can be appropriately reused.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an overall configuration diagram of a system including a vehicle parts information processing device according to an embodiment;

FIG. 2 is a block diagram showing a hardware configuration of the vehicle parts information processing device according to the embodiment;

FIG. 3 is a block diagram showing a hardware configuration of a server according to the embodiment;

FIG. 4 is a block diagram showing a hardware configuration of the vehicle parts information processing device according to the embodiment;

FIG. 5 is a table showing an example of a vehicle information database;

FIG. 6 is a table showing an example of a parts information database;

FIG. 7 is a table showing an example of a remake vehicle information database;

FIG. 8 is a sequence diagram showing an example of a flow of a vehicle parts information process according to the embodiment; and

FIG. 9 is a flowchart showing an example of a flow of an assessment process in the embodiment.

### DETAILED DESCRIPTION OF EMBODIMENTS

A system S including a vehicle parts information processing device 10 according to the embodiment will be described with reference to the drawings.

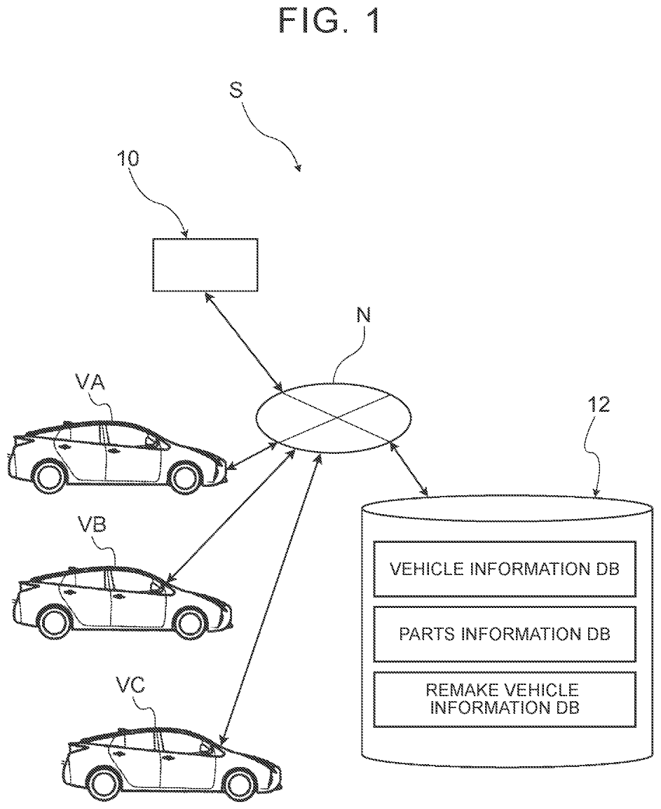

As shown in FIG. 1, the system S according to the present embodiment includes a vehicle parts information processing device 10, a server 12 as a storage unit, and a plurality of vehicles, that is, a vehicle VA, a vehicle VB, and a vehicle VC. Further, the vehicle parts information processing device 10, the server 12, and the vehicle VA, the vehicle VB, and the vehicle VC are connected to each other so as to be able to communicate with each other through a network N. Although three vehicle VA, vehicle VB, and vehicle VC are shown in FIG. 1, a large number of vehicles registered in a predetermined area are actually connected to the network N. Further, in the following description, a plurality of vehicles including the vehicle VA, the vehicle VB, and the vehicle VC is collectively referred to as a vehicle V.

Various data are stored in the server 12. The data stored in the server 12 includes, for example, a vehicle information database in which vehicle information is stored (hereinafter, appropriately referred to as “vehicle information DB”), a parts information database in which data of parts mounted on the vehicle is stored (hereinafter, appropriately referred to as “parts information DB”) and a remake vehicle information database in which a remake vehicle is simulated using parts of a deregistered vehicle (hereinafter, appropriately referred to as “remake vehicle information DB”).

Here, the vehicle parts information processing device 10 according to the present embodiment is configured to update the parts information DB by adding a diagnostic result related to the degree of deterioration from the parts information stored in the parts information DB of the server 12. Further, the vehicle parts information processing device 10 according to the present embodiment is configured to be able to extract mounted parts that satisfy a predetermined condition related to the degree of deterioration.

### Hardware Configuration of Vehicle Parts Information Processing Device 10

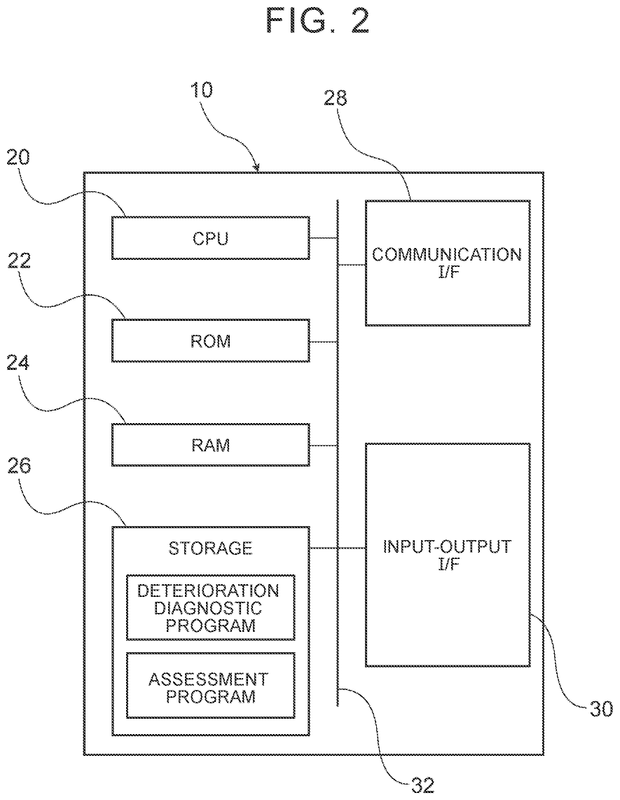

FIG. 2 is a block diagram showing a hardware configuration of the vehicle parts information processing device 10. As shown in FIG. 2, the vehicle parts information processing device 10 is configured to include a central processing unit (CPU: processor) 20, a read-only memory (ROM) 22, a random access memory (RAM) 24, a storage 26, a communication interface 28, and an input-output interface (input-output I/F) 30. Each configuration is communicably connected to each other via a bus 32.

The CPU 20 is a central processing unit that executes various programs and that controls various units. That is, the CPU 20 reads the program from the ROM 22 or the storage 26 and executes the program using the RAM 24 as a work area. The CPU 20 controls each of the above configurations and performs various arithmetic processes in accordance with the program recorded in the ROM 22 or the storage 26.

The ROM 22 stores various programs and various data. The RAM 24 is a non-transitory recording medium that temporarily stores a program or data as a work area. The storage 26 is a non-transitory recording medium that is composed of a hard disk drive (HDD) or a solid state drive (SSD), and stores various programs including an operating system and various data. In the present embodiment, the storage 26 stores a program for executing a deterioration diagnostic process, a program for performing an assessment process, various data, and the like.

The communication I/F 28 is an interface for the vehicle parts information processing device 10 to communicate with the server 12 and other devices, and for example, standards such as a controller area. network (CAN), Ethernet (registered trademark), long term evolution (LTE), fiber distributed data interface (FDDI), and Wi-Fi (registered trademark) are used. The input-output I/F 30 is an interface for connecting to a peripheral device, and a display device such as a display and an input device such as a keyboard are connected, for example.

### Hardware Configuration of Server 12

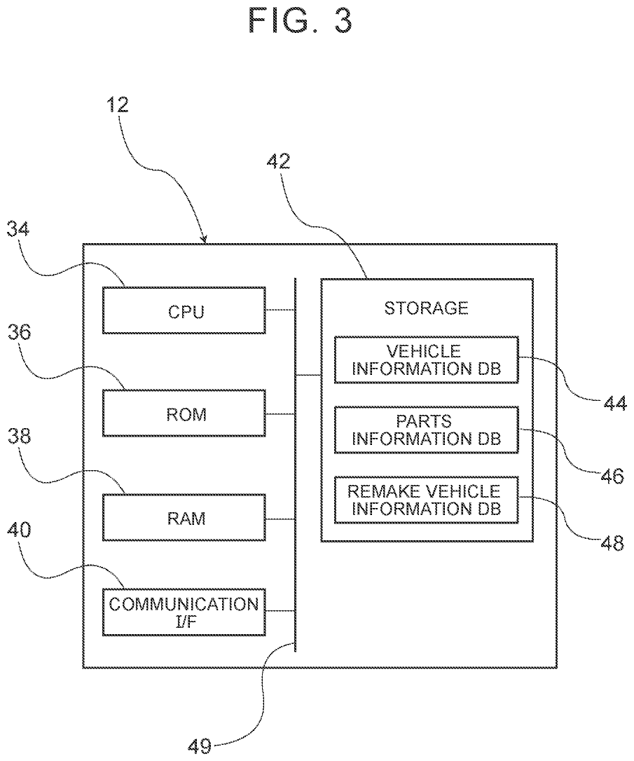

FIG. 3 is a block diagram showing a hardware configuration of the server 12. As shown in FIG. 3, the server 12 is configured to include a central processing unit (CPU: processor) 34, a read-only memory (ROM) 36, a random access memory (RAM) 38, a communication interface (communication I/F) 40, and a storage 42 as a memory. Each configuration is communicably connected to each other via a bus 49.

The CPU 34 is a central processing unit, and executes various programs and controls various units. The ROM 36 stores various programs and various data. The RAM 38 temporarily stores a program or data as a work area.

The communication I/F 40 is an interface for the vehicle parts information processing device 10 to communicate with other devices, and for example, standards such as a controller area network (CAN), Ethernet, long term evolution (LTE), liber distributed data. interface (FDDI), and Wi-Fi are used.

The storage 42 is composed of a hard disk drive (HDD) or a solid state drive (SSD), and stores various programs and various data. In the present embodiment, the storage 42 stores the vehicle information DB 44, the parts information DB 46, and the remake vehicle information DB 48. Hereinafter, an example of the vehicle information DB 44, the parts information DB 46. and the remake vehicle information DB 48 will be described.

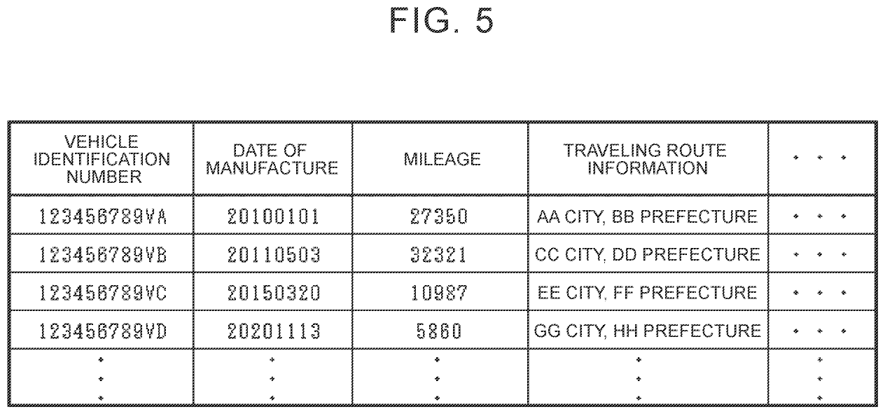

FIG. 5 illustrates an example of the vehicle information DB 44. As shown in FIG. 5, the vehicle information DB 44 stores data such as a vehicle identification number, a date of manufacture, a mileage, and a traveling route. The vehicle identification number is a unique number for each vehicle V, and is assigned at the time of manufacturing the vehicle V, for example. Data on the route on which the vehicle V travels is stored in traveling route information, and, for example, data on an area where the ratio of traveling of the vehicle V is the highest may be stored in the traveling route information. Further, data such as the total mileage of the vehicle V traveling on a rough road may be stored in the traveling route information.

The vehicle information DB 44 stores various data related to the vehicle V, in addition to the vehicle identification number, the date of manufacture, the mileage, and the traveling route. For example, data related to mounted parts, vehicle model, option information, owner information, and the like are stored.

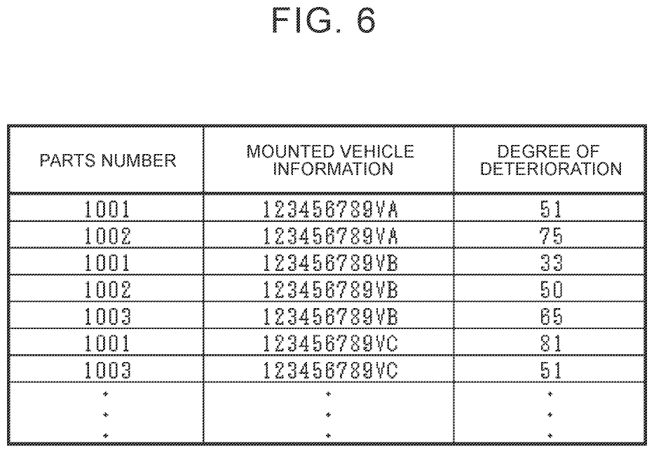

FIG. 6 illustrates an example of the parts information DB 46. As shown in FIG. 6, the parts information DB 46 stores data such as a part number, mounted vehicle information, and a degree of deterioration. The part number is a number assigned to each of the mounted parts, and the same part of the same model is given the same number.

The mounted vehicle information stores the identification number of the vehicle on which the mounted parts are mounted. That is, the parts stored in the parts information DB 46 are mounted parts in a state of being assembled to each vehicle V, and are managed by the parts information DB 46 in a state of being assembled to the vehicle V.

Data related to the degree of deterioration of each mounted part is stored in the degree of deterioration. In the present embodiment, as an example, the degree of deterioration diagnosed by a deterioration diagnostic process that will be described later is stored as a numerical value from 0 to 100. As the value of the decree of deterioration becomes larger, the deterioration is more progressing, and the degree of deterioration is set to 0 when not in use.

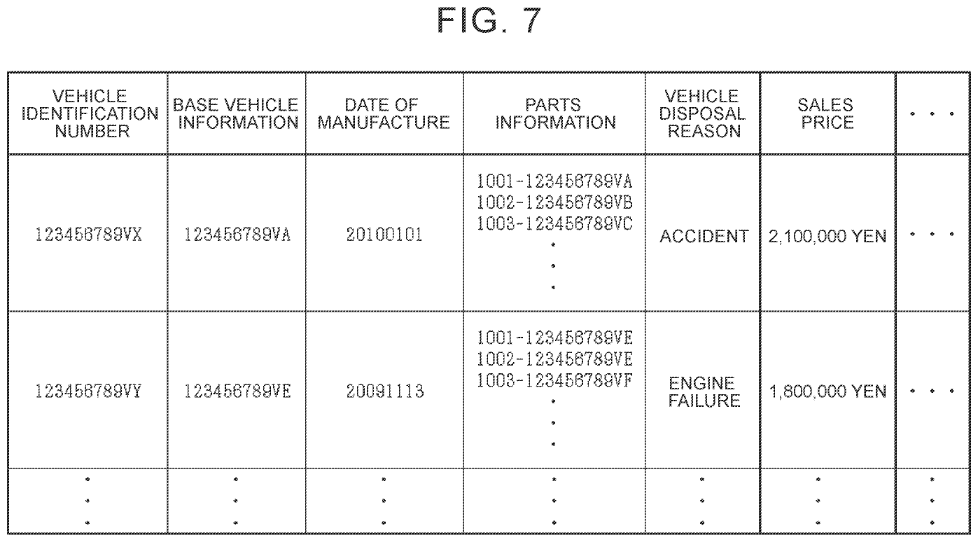

FIG. 7 illustrates an example of the remake vehicle information DB 48. As shown in FIG. 7, the remake vehicle information DB 48 stores data such as the vehicle identification number, base vehicle information, the date of manufacture, the parts information, a vehicle disposal reason, and a sales price.

The vehicle identification number is an identification number assigned when remake simulation is performed, and is a unique number for each vehicle V. Data such as the vehicle identification number of the vehicle used as the base vehicle at the time of remake is stored in the base vehicle information, and the date of manufacture of the base vehicle is stored in the date of manufacture. The term “base vehicle” as used herein refers to a vehicle that uses a vehicle framework and a part of the platform as a base portion when the vehicle is remade.

The parts information stores data of the mounted parts extracted from the parts information DB 46 when the vehicle V is remade on the system by a remake processing unit 56 that will described later. The vehicle disposal reason includes data related to the vehicle disposal reason for the base vehicle and the like. As the vehicle disposal reason, data related to the vehicle disposal reason for the vehicle V on which the respective mounted parts are mounted may be configured to be stored for all the mounted parts stored in the parts information.

The sales price includes the sales price data calculated by the assessment process that will be described later. Although the sales price is stored in yen as an example in FIG. 7, the sales price is not limited to this, and data in other currencies may be used. Moreover, the sales price may be data other than currency.

### Functional Configuration of Vehicle Parts Information Processing Device 10

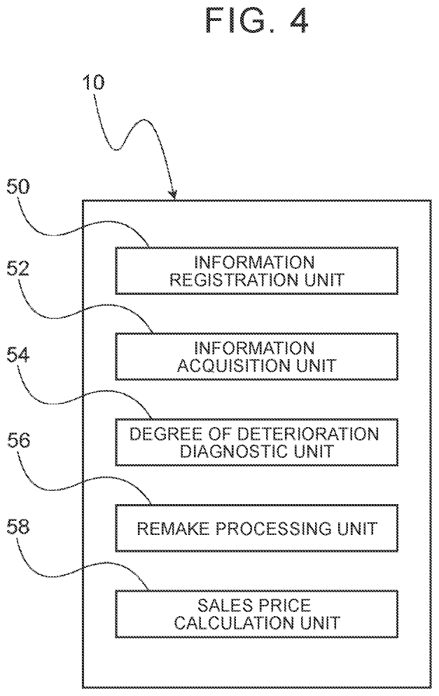

The vehicle parts information processing device 10 realizes various functions using the hardware resources shown in FIG. 2. The functional configuration realized by the vehicle parts information processing device 10 will be described with reference to FIG. 4.

As shown in FIG. 4, the vehicle parts information processing device 10 is configured to include an information registration unit 50, an information acquisition unit 52, a degree of deterioration diagnostic unit 54, a remake processing unit 56, and a sales price calculation unit 58 as functional configurations. Each functional configuration is realized as the CPU 20 reads and executes the program stored in the ROM 22 or the storage 26.

The information registration unit 50 stores various data in a predetermined database of the server 12. Specifically, the information registration unit 50 stores the data related to the vehicle V in the vehicle information DB 44 at the time of manufacturing or at the time of selling the vehicle V, and stores the data of the mounted parts mounted on the vehicle V in the parts information DB 46. At this time, since the degree of deterioration of the mounted parts has not been diagnosed, the data related to the degree of deterioration is not stored.

In the present embodiment, as an example, a label on which a vehicle information code for accessing the vehicle information DB 44 is described is affixed to the vehicle V. Further, a label on which the parts information code for accessing the parts information DB 46 is described is affixed to each mounted part. Therefore, the user and the business operator can easily access the database and confirm the vehicle information and the parts information by reading the vehicle information code affixed to the vehicle V and the parts information code affixed to the mounted parts. Various codes can be applied as the vehicle information code and the parts information code, and for example, a two-dimensional bar code such as a QR code (registered trademark) may be used as the vehicle information code and the parts information code.

Further, the information registration unit 50 periodically stores data transmitted from an in-vehicle communication device such as a data communication module (DCM) in the vehicle information DB 44, the parts information DB 46, and the like. For example, the information registration unit 50 stores data related to a mileage, a traveling route, and the like transmitted from an in-vehicle device, such as a DCM, in the vehicle information DB 44 of the server 12.

Further, the information registration unit 50 stores data related to the degree of deterioration diagnosed by the deterioration diagnostic process that will be described later in the parts information DB 46. Further, the information registration unit 50 stores the data related to the vehicle V remade on the system by the remake processing unit 56 that will be described later in the remake processing unit 56 of the server 12.

Furthermore, when the vehicle V is deregistered, the information registration unit 50 stores the vehicle disposal reason in the vehicle information DB 44.

The information acquisition unit 52 acquires various data from the server 12. For example, the information acquisition unit 52 acquires predetermined data from the parts information DB 46 when the deterioration diagnostic process is executed by the degree of deterioration diagnostic unit 54. Further, the information acquisition unit 52 acquires predetermined data from the vehicle information DB 44 and the parts information DB 46 when the vehicle V is remade by the remake processing unit 56.

The degree of deterioration diagnostic unit 54 diagnoses the degree of deterioration of the mounted parts with respect to the deregistered vehicle V. Specifically, the degree of deterioration diagnostic unit 54 determines the degree of deterioration of the mounted parts based on the data stored in the vehicle information DB 44 related to the vehicle V on which the mounted parts are mounted, the data accumulated by the in-vehicle sensors, the data that is preset for each of the mounted parts, and the like, by executing the deterioration diagnostic process. Then, the degree of deterioration diagnostic unit 54 outputs the diagnostic result of the degree of deterioration as a numerical value from 0 to 100.

The degree of deterioration diagnostic unit 54 may be configured to output the degree of deterioration by inputting predetermined data to a trained model such as a neural network that has been machine-learned in advance. In this case, the degree of deterioration diagnostic unit 54 may input the part number, the mileage, the traveling route information, the input load information input to the vehicle V, and the like to the trained model as input data. Further, as the trained model, a trained model generated by machine learning using the teacher data in which the part number, the mileage, the traveling route information, the input load information, and the degree of deterioration are associated with each other may be used.

The data related to the degree of deterioration of the mounted part diagnosed by the degree of deterioration diagnostic unit 54 is stored in the parts information DB 46 by the information registration unit 50 as described above. Here, as an example in the present embodiment, a configuration is adopted in which the parts information of the mounted part of which degree of deterioration is larger than a predetermined threshold value is deleted from the parts information DB 46 since the mounted part is a disposal target part that cannot be used as a remake vehicle.

The remake processing unit 56 extracts mounted parts satisfying a predetermined condition related to the degree of deterioration from the data stored in the vehicle information DB 44 and the parts information DB 46, and generates the data of the remake vehicle. Specifically, the remake processing unit 56 extracts mounted parts of which degree of deterioration is within a predetermined range from the data stored in the parts information DB 46.

Further, the remake processing unit 56 generates data for the remake vehicle with the base vehicle and the extracted mounted parts as a set, and assigns a unique vehicle identification number. The data of the remake vehicle generated by the remake processing unit 56 is stored in the remake vehicle information DB 48 by the information registration unit 50 as described above.

The sales price calculation unit 58 calculates the sales price of the remake vehicle by executing the assessment process. Here, as an example in the present embodiment, the sales price calculation unit 58 calculates the sales price in consideration of the vehicle information of the vehicle in which each of the extracted mounted parts is mounted. For example, when the location of the vehicle on which the mounted parts are mounted is far, the sales price is calculated to be higher than when the location is near. In addition, the sales price is calculated high in accordance with the number of vehicles V that need to be disassembled in order to collect the mounted parts. The data related to the sales price calculated by the sales price calculation unit 58 is stored in the remake vehicle information DB 48 by the information registration unit 50 as described above.

### Effect

Next, the effect of the present embodiment will be described.

### Example of Processing

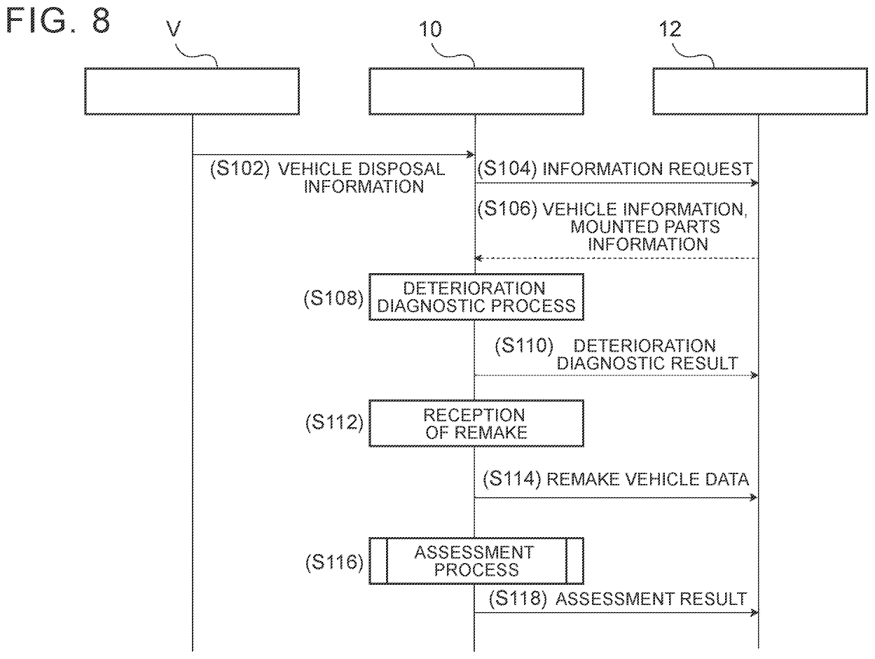

FIG. 8 is a sequence diagram showing an example of the processing flow by the system S in the present embodiment, and describes the vehicle V, the vehicle parts information processing device 10, and the server 12.

In step S102 in FIG. 8, vehicle disposal information is transmitted from the vehicle V to the vehicle parts information processing device 10. The vehicle disposal information may be transmitted from a maintenance shop or the like that has received a vehicle disposal request for the vehicle V.

In step S104, the vehicle parts information processing device 10 requests data from the server 12 using the function of the information acquisition unit 52, and in step S106, the vehicle information of the vehicle V and the parts information of the mounted parts are transmitted from the server 12.

In step S108, the deterioration diagnostic process is performed by the degree of deterioration diagnostic unit 54. In the present embodiment, as an example, the degree of deterioration diagnostic unit 54 acquires the degree of deterioration output by inputting the part number, the mileage, the traveling route information, and the input load information to the trained model as input data.

In step S110, the deterioration diagnostic result is stored in the server 12 for each mounted part using the function of the information registration unit 50.

In step S112, a request for data generation of the remake vehicle is received. In the present embodiment, as an example, the data generation of the remake vehicle is started after a generation request for the remake vehicle data is received. However, the present embodiment is not limited to this. That is, the data of the remake vehicle may be generated periodically. Further, when the number of mounted parts of which degree of deterioration has been diagnosed reaches a certain level or more, data generation of the remake vehicle may be started.

In step S114, the vehicle parts information processing device 10 generates data for the remake vehicle with the base vehicle and the extracted mounted parts as a set using the function of the remake processing unit 56, and assigns a unique vehicle identification number. The data of the remake vehicle to which the unique vehicle identification number is assigned is stored in the server 12 together with the data of the mounted parts.

In step S116, the assessment process is executed using the function of the sales price calculation unit 58. Details of the assessment process will be described below.

In step S118, the sales price of the remake vehicle is stored in the server 12 using the function of the information registration unit 50.

### Assessment Processing

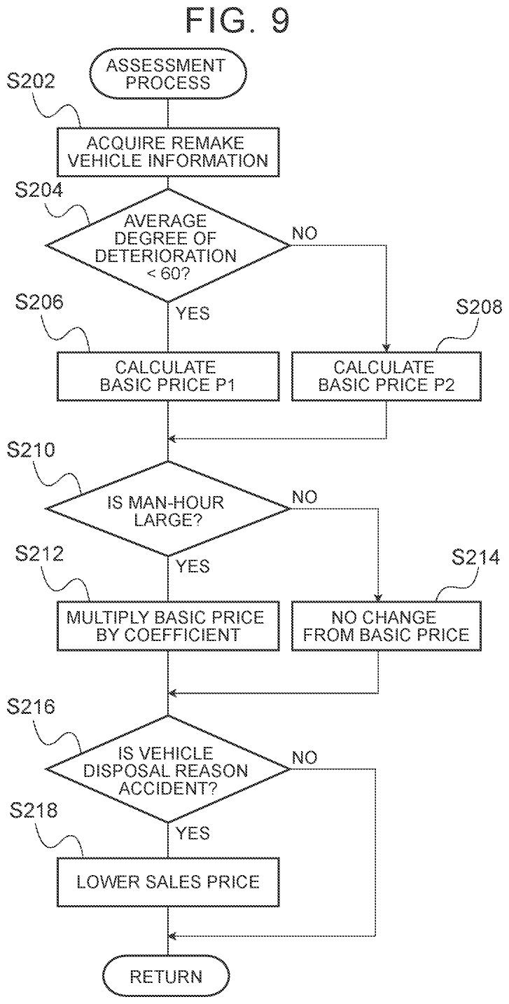

FIG. 9 is a flowchart showing an example of the flow of the assessment process by the vehicle parts information processing device 10 according to the present embodiment. This assessment process is executed by the CPU 20 as the CPU 20 reads an assessment program from the storage 26 and expands the read program to the RAM 24.

In step S202 in FIG. 9, the CPU 20 acquires the data of the remake vehicle to be assessed from the remake vehicle information DB 48 of the server 12 using the function of the information acquisition unit 52.

The CPU 20 determines in step S204 whether the average degree of deterioration of the mounted parts is less than 60. Specifically, the CPU 20 acquires the degree of deterioration of each of the mounted parts stored in the remake vehicle information DB 48, and calculates the average degree of deterioration. Here, since the degree of deterioration of the mounted parts constituting the remake vehicle is within a predetermined range, there is no significant difference between the degree of deterioration of each of the mounted parts and the average degree of deterioration. Further, the threshold value of 60 is an example, and other numerical values may be used as the threshold value.

When the average degree of deterioration is smaller than 60 in step S204, the CPU 20 proceeds to the process in step S206 and calculates a basic price P1. On the other hand, when the average degree of deterioration is larger than 60 in step S204, the CPU 20 proceeds to the process in step S208 and calculates a basic price P2. At this time, the basic price P2 is calculated to be lower than the basic price P1.

The CPU 20 determines whether the man-hour for collecting the mounted parts in step S210 is larger than the standard man-hour. For example, when the location of the vehicle V on which the mounted parts are mounted is far away, the CPU 20 determines that the man-hour is large in consideration of transportation of the mounted parts and the like, and proceeds to the process in step S212. Further, when it takes time to take out the mounted parts due to an accident or the like, the CPU 20 determines that the man-hour is larger than the standard man-hour, and proceeds to the process in step S212.

The CPU 20 sets the amount obtained by multiplying the basic price by a coefficient in step S212 as the sales price. On the other hand, when the CPU 20 determines in step S210 that the man-hour is not larger than the standard man-hour, the CPU 20 proceeds to the process in step S214 and sets the sales price without changing from the basic price.

The CPU 20 determines in step S216 whether the vehicle disposal reason is an accident. Specifically. the CPU 20 refers to the vehicle disposal reason of the base vehicle from the remake vehicle information DB 48, and when the reason is an accident, the CPU 20 proceeds to the process in step S218.

The CPU 20 lowers the sales price in step S218. That is, when the vehicle disposal reason is an accident, the official sales price is set by subtracting a predetermined ratio from the sales price set in step S212 or step S214.

On the other hand, when the vehicle disposal reason is other than an accident in step S216, the CPU 20 does not lower the sales price and sets the sales price set in step S212 or step S214 as the official sales price. Then, the CPU 20 ends the assessment process.

As described above, in the vehicle parts information processing device 10 according to the present embodiment, the server 12 that is a storage unit stores the parts information related to the mounted parts mounted on the vehicle. Then, the vehicle parts information processing device 10 acquires the parts information from the server 12, adds the diagnostic result related to the degree of deterioration to the parts information, and updates the parts information. With the above, the parts information stored in the server 12 includes information related to the degree of deterioration of the mounted parts.

Further, the vehicle parts information processing device 10 extracts mounted parts satisfying a predetermined condition related to the degree of deterioration from the parts information stored in the server 12. With the above, for example, only the mounted parts having the same degree of deterioration can be extracted, and only the mounted parts having the same degree of deterioration can be reused to remake the vehicle.

Further, in the present embodiment, the vehicle can be remade using only the mounted parts of which degree of deterioration of the mounted parts is within a predetermined range.

Furthermore, in the present embodiment, the sales price of the vehicle can be calculated on the system using the function of the sales price calculation unit 58 before the vehicle is actually remade. At this time, since the parts information and the information related to the sales price are stored in the remake vehicle information DB 48 of the server 12, the mounted parts can be efficiently collected and the sales preparation can be performed when the remake of the vehicle is determined.

Further, in the present embodiment, the sales price is calculated in consideration of the location of the vehicle on which the mounted parts are mounted and the man-hours required for disassembling the vehicle and taking out the mounted parts. With the above, a more accurate sales price can be calculated as compared with a configuration in which the sales price is calculated without considering the man-hours.

Further, in the present embodiment, the parts information of the mounted part having a large degree of deterioration is deleted from the server 12. With the above, only the information of the parts that can be used for the remake of the vehicle V can be accumulated.

The vehicle parts information processing device 10 in accordance with the embodiment and the modification have been described above. However, it is understood that the parts information processing device 10 can be implemented in various modes without departing from the scope of the present disclosure. In the above embodiment, the degree of deterioration of the mounted part is converted into data with a numerical value from 0 to 100. However, the data is not limited to this, and other numerical values may be used for calculation. Further, the degree of deterioration may be calculated by an index other than the numerical value, and may be evaluated in five stages of A, B, C, D and E, for example. In this case, when the degree of deterioration is evaluated such that A has the lowest degree of deterioration and E has the highest degree of deterioration, the mounted parts having the same evaluation value can be extracted, whereby it is possible to generate data for a complete remake vehicle to keep the degrees of deterioration within a certain range.

Further, in the above embodiment, the degree of deterioration diagnostic unit 54 diagnoses the degree of deterioration by inputting the part number, the mileage, the traveling route information, the input load information input to the vehicle V, and the like to the trained model as input data. However, the present disclosure is not limited to this. For example, the degree of deterioration diagnostic unit 54 may diagnose the degree of deterioration based only on the traveling environment of the vehicle V. In this case, the vehicle may be remade by extracting the mounted parts of the vehicle having similar traveling routes and traveling areas.

Further, in the above embodiment, various data are stored in the database including the vehicle information DB 44, the parts information DB 46, and the remake vehicle information DB 48. However, the present disclosure is not limited to this. For example, the vehicle information and the parts information may be managed in one database. Further, all of the vehicle information, the parts information and the remake vehicle information may be managed in one database.

Further, in the above embodiment, the sales price calculation unit 58 calculates the sales price based on the average degree of deterioration of the mounted parts, the man-hours, and the vehicle disposal reason, as shown in FIG. 9. However, the present disclosure is not limited to this. For example, the sales price calculation unit 58 may calculate the sales price based on data such as changes in the market price, information on popular vehicle models, and the number of purchase applicants, in addition to the above items.

Furthermore, in the above embodiment, the method of remaking the vehicle by mounting the mounted parts on the base vehicle has been described. However, the present disclosure is not limited to this. For example, a newly manufactured vehicle framework may be used. Even in this case, the vehicle can be remade at a low cost and while suppressing resources using the parts mounted on the disposed vehicle for most of the parts mounted on the vehicle.

Further, various processors other than the CPU 20 may execute the process executed by the CPU 20 by reading the program in the above embodiment. In this case, a programmable logic device (PLD) in which a circuit configuration can be changed after manufacturing, such as a field-programmable gate array (FPGA), and a dedicated electric circuit or the like that is a processor having a circuit configuration specially designed to execute a specific process, such as an application specific integrated circuit (ASIC), are exemplified as a processor in this case. In addition, each process may be executed by one of these various processors, or may be executed by a combination of two or more processors of the same kind or different kinds. For example, the processes may be executed by a plurality of FPGAs, a combination of the CPU and the FPGA, and the like. The hardware structure of these various processors is, more specifically, an electric circuit in which circuit elements such as semiconductor elements are combined.

Further, in the above embodiment, each program has been described in a manner of being stored (installed) in advance in a non-transitory recording medium (non-transitory storage medium) readable by a computer. However, the present disclosure is not limited to this, and each program may be provided in a format recorded in a non-transitory recording medium such as a compact disc read-only memory (CD-ROM), a digital versatile disc read-only memory (DVD-ROM), and a universal serial bus (USB) memory. Further, the program may be downloaded from an external device via a network.

Further, the flow of processes and databases described in the above embodiment are an example, and unnecessary steps may be deleted, new steps may be added, or the process order may be changed within a range that does not deviate from the gist.

What is claimed is:

1. A vehicle parts information processing device comprising a processor, wherein the processor:
acquires parts information from a storage unit that stores the parts information related to a mounted part mounted on a vehicle;
adds a diagnostic result related to a degree of deterioration to the parts information and updates the parts information stored in the storage unit; and
extracts the mounted part satisfying a predetermined condition related to the degree of deterioration from the parts information stored in the storage unit.

2. The vehicle parts information processing device according to claim 1, wherein the processor extracts the mounted part of which the degree of deterioration is within a predetermined range from the diagnostic result for each of the mounted parts constituting the vehicle.

3. The vehicle parts information processing device according to claim 2, wherein the processor calculates a sales price of the vehicle when the vehicle is remade using the extracted mounted part, and stores the parts information of the extracted part and information related to the sales price in the storage unit.

4. The vehicle parts information processing device according to claim 3, wherein the processor calculates the sales price in consideration of vehicle information of the vehicle on which each of the extracted mounted parts is mounted.

5. The vehicle parts information processing device according to claim 1, wherein the processor deletes the parts information of the mounted part of which the degree of deterioration is large from the storage unit.

6. A vehicle parts information processing method comprising:
acquiring parts information from a storage unit that stores the parts information related to a mounted part mounted on a vehicle;
adding a diagnostic result related to a degree of deterioration to the parts information and updating the parts information stored in the storage unit; and
extracting the mounted part satisfying a predetermined condition related to the degree of deterioration from the parts information stored in the storage unit.

7. A non-transitory storage medium storing a program that causes a computer to execute processes comprising:
acquiring parts information from a storage unit that stores the parts information related to a mounted part mounted on a vehicle;
adding a diagnostic result related to a degree of deterioration to the parts information and updating the parts information stored in the storage unit; and
extracting the mounted part satisfying a predetermined condition related to the degree of deterioration from the parts information stored in the storage unit.
